(19) United States
(12) Patent Application Publication
(10) Pub. No.: US 2020/0026427 A1
(43) Pub. Date: Jan. 23, 2020

(54) SYSTEM AND METHOD FOR HANDLING DATA STORAGE ON STORAGE DEVICES

(71) Applicant: Reduxio Systems Ltd., Tel-Aviv (IL)

(72) Inventors: Nir Peleg, Tel-Aviv (IL); Or Sagi, Tel-Aviv (IL)

(73) Assignee: Reduxio Systems Ltd., Tel-Aviv (IL)

(21) Appl. No.: 16/452,551

(22) Filed: Jun. 26, 2019

Related U.S. Application Data
(60) Provisional application No. 62/701,996, filed on Jul. 23, 2018.

(51) Int. Cl. G06F 3/06; G06F 11/10; G06F 13/42

(52) U.S. Cl. CPC G06F 3/064; G06F 3/0619; G06F 3/0679; G06F 11/1004; G06F 13/4282; G06F 3/0658

(57) ABSTRACT

A system and a method of handling data on at least one storage device may include, with a controller, receiving, from a computing device, a first request for storing on storage media at least one data segment, comprising one or more data blocks and at least one respective metadata object; storing the data blocks and respective metadata object concurrently on the storage media, wherein the metadata object comprises a fidelity flag set to ‘False’; sending an acknowledgement to the computing device; validating the storage of at least one data block of the data segment in an offline validation process; determining the value of at least one fidelity flag associated with the data segment, according to an outcome of the offline validation process; and updating the value of the fidelity flag in the storage media.

### CROSS-REFERENCE TO RELATED APPLICATIONS

This application claims the benefit of U.S. Patent Application No. 62/701,996, filed Jul. 23, 2018, entitled “SYSTEM AND METHOD FOR HANDLING DATA STORAGE ON STORAGE DEVICES” which is hereby incorporated by reference.

### FIELD OF THE INVENTION

The present invention relates generally to storage control systems. More specifically, the present invention relates to methods and systems for handling or performing data storage on at least one storage device.

### BACKGROUND OF THE INVENTION

Commercially available storage systems commonly store, in addition to actual data content, metadata relating to the value of stored data. For example, content-addressable memory (CAM) systems may store on the underlying storage media metadata that is indicative of the value (as opposed to the address or location) of the stored data (e.g. a hash value thereof). A storage controller may then search the storage media to locate data that corresponds to the provided metadata. In another example, a storage system may store metadata in the form of a cyclic redundancy check (CRC) value associated with respective stored data to identify and/or fix errors in the stored data and compare between different storage instances.

Such systems commonly perform storage of the data and metadata in a serial manner, in order to ensure consistency in case of failures, and thus typically impose high latency on a computing device that may request access to the storage media.

### SUMMARY OF THE INVENTION

A system and a method that would facilitate handling of data storage by one or more clients on storage media and utilize an optimal work bandwidth is therefore desired.

Embodiments of the invention may include a method of handling data on at least one storage device by one or more controller and/or processor.

Embodiments of the method may include receiving (e.g., from a computing device) a first request (e.g., a storage access request) for storing on storage media at least one first data segment or object, including one or more first data blocks and at least one first respective metadata object. The content of the at least one first metadata object may correspond to content of the one or more first data objects and/or the one or more first data blocks.

Additionally, or alternatively, embodiments may calculate a value of the at least one first metadata object from the content or value of the respective one or more data objects and/or data blocks. For example, the value of the at least one metadata object may be a cryptographic hash value or a cyclic redundancy check (CRC) value of a content of the respective one or more data objects and/or data blocks.

Embodiments of the invention may store the one or more first data blocks and the at least one respective first metadata object on the storage media. Additionally, or alternatively, embodiments of the invention may store the one or more first data blocks and the at least one respective first metadata object on the storage media concurrently (e.g., substantially at the same time, or overlapping in time) so as not to require a plurality of iterations or communications with the computing device (e.g., the computer from which the storage access request was received).

Embodiments of the invention may send an acknowledgement to the computing device (e.g., the computer from which the storage access request was received). For example, the acknowledgement may indicate that the request to store was received by embodiments of the invention and may not indicate the validity or correctness of the stored data or the storage process.

In some embodiments, the at least one respective metadata object may include a fidelity flag, initially set to ‘False’ in the storage media.

Embodiments of the invention may validate the storing of at least one of the one or more data blocks in an offline validation process, as elaborated herein.

Embodiments of the invention may include one or more offline validation processes, as elaborated herein. The one or more offline validation processes may include a comparison between content or value of one or more metadata objects, as elaborated in relation to each offline validation process elaborated herein. For example, an offline validation process may be considered successful if a value or a content of one or more first metadata objects is compared to and found equal to a value or a content of one or more second metadata objects. In a complementary manner, an offline validation process may be considered unsuccessful if a value or a content of one or more first metadata objects is compared to and found unequal to a value or a content of one or more second metadata objects, as elaborated herein.

Embodiments of the invention may determine a value of at least one fidelity flag that may be associated with the stored data segment or object according to an outcome of the offline validation process and may update the value of the fidelity flag (e.g., in the storage media) accordingly. For example, if the offline validation process was successful, a value of the fidelity flag may be updated or set to ‘True’. Additionally, or alternatively, if the offline validation process was unsuccessful, embodiments of the invention may discard, erase or purge the stored metadata object (e.g., from the storage media).

According to some embodiments, validation of storage of the at least one data block in an offline validation process by the one or more controller or processor may include receiving (e.g., from a computing device), a second request for storing the at least one data segment, where the second request may include one or more data objects and comparing the content of one or more data objects stored on the storage media to the one or more data objects of the second request.

The offline validation process may be considered successful if, for example, a content or value of the one or more data objects stored on the storage media is equal to a content of the one or more data objects of the second request, and may be considered unsuccessful if, for example, if a content or value of the one or more data objects stored on the storage media is unequal to a content of the one or more data objects of the second request.

Additionally, or alternatively, validation of storage of at least one data block in an offline validation process may include:
reading the at least one data block stored on the storage media;
reading at least one respective metadata object stored on the storage device;
producing or calculating one or more metadata objects from the at least one read data block; and
comparing the content of the one or more read metadata object of the first request to the one or more produced metadata objects.

The offline validation process may be considered successful if, for example, a content or value of the one or more read metadata objects of the first request is equal to a content or value of the one or more produced metadata objects and may be considered unsuccessful if, for example, a content or value of the first request is unequal to a content or value of the one or more produced metadata objects.

According to some embodiments, reading the data block stored on the at least one storage device may be prompted by at least one of:
receiving (e.g., from a computing device) a request for reading the at least one data block from the at least one storage device;
receiving an asynchronous interrupt or message from at least one hardware module;
receiving a synchronous interrupt or message from at least one hardware module; receiving at least one asynchronous interrupt or message from a software process; and
receiving at least one synchronous interrupt or message from a software process.

Embodiments of the method may include:
receiving a first request to access a data segment on the at least one storage device;
storing one or more metadata objects associated with the data segment of the first request in a cache memory device;
receiving a second request to access the data segment, that may include one or more metadata objects; and
validating the storage of the at least one data block in an offline validation process by comparing the one or more metadata objects of the second received request to the one or more metadata objects that may be stored on the cache memory device.

The offline validation process may be considered successful if, for example, a content or value of the one or more metadata objects of the second received request is equal to a content or value of the one or more metadata objects that may be stored on the cache memory device and may be considered unsuccessful if, for example, a content or value of the one or more metadata objects of the second received request is unequal to a content or value of the one or more metadata objects that may be stored on the cache memory device.

Embodiments of the method may include maintaining a metadata table, wherein at least one entry may be configured to associate at least one value or content of a metadata object (e.g., corresponding to at least one stored data block), to at least one fidelity flag. Embodiments may thus maintain the condition of fidelity of at least one data block stored on the storage media.

Validating the storage of the one or more data blocks in an offline validation process may include:
receiving, from a computing device, a second request for storing the at least one data segment, wherein the second request may include one or more metadata objects; and
comparing the content of the one or more metadata objects of the second request with the content of metadata objects stored on the storage media.

Validating the storage of the one or more data blocks in an offline validation process may include:
reading, by the controller, the one or more first data blocks stored on the storage media;
reading, by the controller, the at least one first, respective metadata object stored on the storage media;
producing, by the controller, at least one second metadata object from the one or more first, read data block; and
comparing, by the controller, the content of the at least one first read metadata object to the content of the at least one second, produced metadata object.

The offline validation process may be considered successful if, for example, a content or value of the at least one first read metadata object is equal to a content or value of the at least one second, produced metadata object and may be considered unsuccessful if, for example, a content or value of the at least one first read metadata object is unequal to a content or value of the at least one second, produced metadata object.

According to some embodiments, reading the at least one data block stored on the at least one storage device may be prompted by at least one of:
receiving, from a computing device, a request for reading the at least one data block from the at least one storage device;
receiving an asynchronous interrupt or message from at least one hardware module;
receiving a synchronous interrupt or message from at least one hardware module;
receiving at least one asynchronous interrupt or message from a software process; and
receiving at least one synchronous interrupt or message from a software process.

Validating the storage of the one or more data blocks in an offline validation process may include:
receiving, a first request to access a data segment may include one or more data blocks on the at least one storage device, wherein said first request may include one or more first metadata objects corresponding to content of the data segment;
storing the one or more first metadata objects in a cache memory device;
receiving a second request to access the data segment, may include one or more second metadata objects; and
comparing (e.g., determining an equality of) the content of one or more second metadata objects to the content of one or more first metadata objects that may be stored on the cache memory device.

Validating the storage of the one or more data blocks in an offline validation process may include:
receiving, from a computing device, a storage access request to read one or more data blocks from the storage media, wherein the request may include at least one first metadata value;
reading the one or more data blocks and at least one corresponding fidelity flag from the storage media.

According to some embodiments, if the value of the fidelity flag is ‘False’, then embodiments may calculate, by the computing device, a second metadata value from the content of the one or more read data blocks. Additionally, or alternatively, if the first metadata value and the second metadata value match (e.g., are equal) then embodiments may receive from the computing device, a message to the controller to update the fidelity flag to ‘True’ and update the value of the fidelity flag accordingly (e.g., to ‘True’).

Embodiments of the present invention may include a method of performing offline validation of data storage on computer storage media by one or more controllers. Embodiments of the method may include:
receiving a one or more data objects;
calculating at least one metadata value from the content of the one or more data objects;
storing the one or more data objects and the at least one metadata value on the storage media; and
validating the storage of the one or more data objects in an offline validation process.

The offline validation process may be selected from a list consisting of:
offline rewriting of the stored data object by the one or more controllers;
offline reading of the stored data object by the one or more controllers;
offline reading of the stored data object by one or more client computing devices; and
offline reading of the stored data object by a caching system.

Embodiments of the method may further include:
storing at least one fidelity flag associated with at least one respective metadata object on the storage media;
attributing an initial ‘False’ value to the at least one fidelity flag; and
updating or setting the value of at least one fidelity flag according to an outcome of the offline validation process (e.g., set the value to ‘True’ if the validation was successful, and keep it as ‘False’ if the validation was unsuccessful).

Additionally, or alternatively, if the offline validation process was unsuccessful, embodiments of the invention may discard, erase or purge the stored metadata object from the storage media.

Embodiments of the present invention may include a system for handling data on at least one storage device. Embodiments of the system may include: a non-transitory memory device, wherein modules of instruction code may be stored, and a controller associated with the memory device, and configured to execute the modules of instruction code, whereupon execution of said modules of instruction code, the processor may be configured to perform at least one method for handling data on at least one storage device, as elaborated herein.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a flow diagram, depicting a method of handling storage of data segments by a commercially available storage controller according to the state of the art;

FIG. 2 is a block diagram, depicting a computing system which may be included in a system for handling or performing data storage on at least one storage device, according to some embodiments;

FIG. 3 is a block diagram, depicting a storage control system for handling or performing data storage on at least one storage device, according to some embodiments; and

FIG. 4 is a flow diagram, depicting a method of handling or performing data storage on at least one storage device, according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention include a method and a system for handling or performing data storage on at least one storage device, e.g. a computer storage device typically storing digital data. More specifically, embodiments may include a method and a system for expediting the storage of data segments that may include one or more data blocks and respective one or more metadata blocks.

The term data block may be used herein to refer to a sequence of data bytes that may be stored or recorded on a physical storage media, as known to persons skilled in the art.

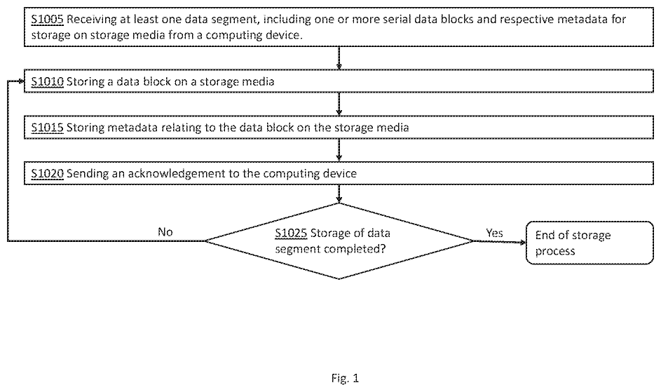

Reference is now made to FIG. 1, which is a flow diagram, depicting a method of handling storage of data segments by a commercially available storage controller according to the state of the art.

As shown in step S1005, a storage control system may receive at least one data segment, including one or more data blocks and respective metadata for storage on storage media from a computing device.

The term “storage device” may be used herein to refer to any type of device that is configured to facilitate storage of computer-related or digital data, typically on a computer storage media. The term “storage media” as used herein, includes the plural and singular and may also be used interchangeably with the term “storage device(s)”, according to the context.

For example, the storage media may be non-volatile memory (NVM) media, including one or more NVM devices (e.g., flash devices, SSD devices and the like). The storage controller may, for example, be an NVM controller, configured to interface at least one computing device (e.g. a client computer), and to control the storage of the one or more storage devices to facilitate at least one data access request (e.g., read request, write request, etc.) of the at least one computing device vis a vis the storage media.

The storage control system may facilitate a content-addressable memory (CAM), in which a user or a computing device may provide metadata that is indicative of the value (as opposed to the address) of the stored data (e.g. a hash value thereof), and the storage controller may search the storage media to locate data that corresponds to the provided metadata, as known to persons skilled in the art.

As shown in step S1010, the storage control system may store at least one data block of the received data segment on the storage media, as known in the art.

As shown in step S1015, the storage control system may store metadata such as cryptographic hash value and/or CRC value, corresponding to the data block on the storage media. The storage operations of steps S1010 and S1015 are performed serially, and S1015 commences only after S1010 has completed.

As shown in steps S1020 and S1025, the storage control system may send or transmit an acknowledgement to the computing device which originated the storage write-access request and continue to store additional data blocks, until the storage of the data segment is completed.

The method elaborated above in relation to FIG. 1 may be regarded as timewise inefficient, because individual, serial storage of data blocks and metadata blocks included in the requested data segment one at a time is timewise inferior to a single, concurrent storage of all the data blocks and metadata blocks of the requested data segment. Furthermore, the method elaborated above does not include validation of the storage of the requested data segment.

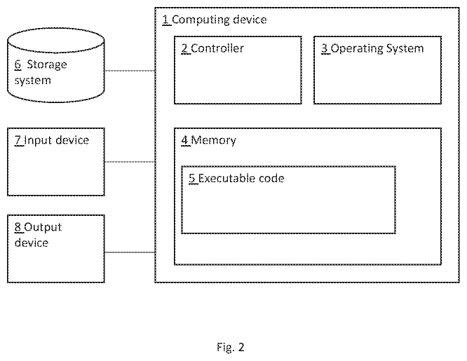

Reference is now made to FIG. 2, which is a block diagram depicting a computing device, which may be included within an embodiment of a system for handling or performing data storage on at least one storage device, according to some embodiments.

Computing device 1 may include a controller 2 that may be, for example, a central processing unit (CPU) processor, a chip or any suitable computing or computational device, an operating system 3, a memory 4, executable code 5, a storage system 6, input devices 7 and output devices 8. Controller 2 (which may be or may include or one or more controllers or processors, possibly across multiple units or devices) may be configured to carry out methods described herein, and/or to execute or act as the various modules, units, etc. More than one computing device 1 may be included in, and one or more computing devices 100 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory 4 may be or may include a plurality of, possibly different memory units. Memory 4 may be a computer or processor non-transitory readable medium, or a computer non-transitory storage medium, e.g., a RAM.

Executable code 5 may be any executable code, e.g., an application, a program, a process, task or script. Executable code 5 may be executed by controller 2 possibly under control of operating system 3. For example, executable code 5 may be an application that may handle data storage on storage devices, as further described herein. Although, for the sake of clarity, a single item of executable code 5 is shown in FIG. 2, a system according to some embodiments of the invention may include a plurality of executable code segments similar to executable code 5 that may be loaded into memory 4 and cause controller 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Content may be stored in storage system 6 and may be loaded from storage system 6 into memory 120 where it may be processed by controller 2. In some embodiments, some of the components shown in FIG. 2 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to computing device 1 as shown by blocks 7 and 8.

A system according to some embodiments of the invention may include components such as, but not limited to, a plurality of central processing units (CPU) or any other suitable multi-purpose or specific processors or controllers (e.g., controllers similar to controller 2), a plurality of input units, a plurality of output units, a plurality of memory units, and a plurality of storage units.

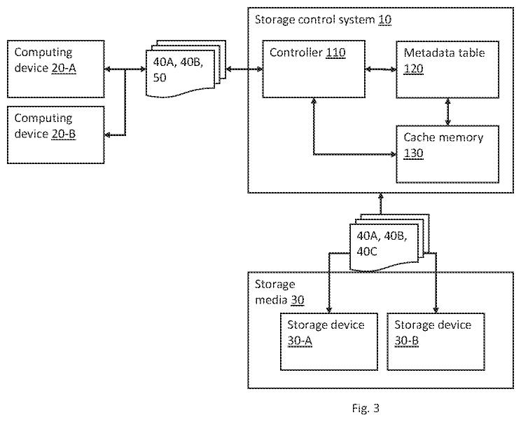

Reference is now made to FIG. 3, which depicts a storage control system 10, according to some embodiments. Storage control system 10 may be implemented as a hardware module and/or a software module or any combination thereof. For example, storage control system 10 may be implemented as a computing device (e.g., element 1 of FIG. 2), and controller 110 may be implemented as at least one controller or processor (e.g., element 2 of FIG. 2).

Storage control system 10 may be communicatively connected to at least one additional computing device 20 (e.g. 20-A, 20-B), and may receive therefrom at least one data segment 40A, including one or more serial data blocks and respective metadata 40B for storage on storage media 30.

Storage media 30 may include for example, one or more NVM devices (e.g. 30-A and 30-B), such as NVM flash devices, SSD devices and the like. Storage control system 10 may be an NVM controller, configured to interface at least one computing device 20 (e.g. a client computer), as known in the art.

Storage control system 10 may control the one or more storage devices (e.g. 30-A and 30-B) of storage media 30, to facilitate at least one data access request (e.g., a read request, a write request, etc.) of the at least one computing device or client 20 to storage media 30.

In some embodiments, storage control system 10 may facilitate a Content-Addressable Memory (CAM) configuration, which is also commonly referred to as associative memory or associative storage in the art. Computing device 20 (e.g. 20-A. 20-B) may provide a metadata object 40B, the value of which may be indicative of, or corresponding to the value of at least one data block stored on storage media 30 (e.g., 40A). For example, the metadata object may include a hash value of the stored data, a Cyclic Redundancy Check (CRC) value of the stored data and the like. Storage control system 10 may search the storage devices of storage media 30, to locate matching stored data objects thereon, that correspond to the provided metadata value 40B. The storage device may return the address of the matching data or the value of the matching data itself, as known to persons skilled in the art.

In some embodiments, metadata object 40B may be stored on at least one data storage block within storage media 30 and may include (e.g. as a field within the metadata object) a fidelity flag 40C signifying a status of validity of the stored at least one data block, as explained herein.

Additionally, or alternatively, fidelity flag 40C may be stored on storage media 30 as a separate entity from the respective metadata object, but may still be associated with the metadata object. For example, validity flag 40C may be stored on the same data block as the associated metadata object 40A or may be pointed or referred to by a pointer that may be included in the metadata object 40A.

According to some embodiments, storage control system 10 may include a cache memory 130, that may include or may be implemented as part of a memory device associated with storage control system 10 (e.g., element 4 or element 6 of FIG. 2). Storage control system 10 may control cache memory 130, to store at least one metadata object 40B associated with at least one data segment and/or data block 40A, that may be included in a storage access request of at least one computing device or client 20, as elaborated herein.

According to some embodiments, storage control system 10 may include a metadata table 120, associated with or included within cache memory 130. Metadata table 120 may be configured to associate, in each entry, at least one content of a metadata block or object 40B (e.g. a metadata value corresponding to at least one stored data block 40A) with at least one fidelity flag 40C. Storage control system 10 may thus maintain the condition of fidelity of at least one data block 40A stored on at least one storage device (e.g., 30A. 30B) of storage media 30, as explained herein.

According to some embodiments, metadata table 120 may be stored and/or maintained within a memory or storage device associated with controller 110 (e.g. element 4 and/or element 6 of FIG. 2). Additionally, or alternatively, metadata table 120 may be stored and/or maintained as part of cache memory 130. Additionally, or alternatively, metadata table 120 may be stored and/or maintained on at least one data storage block within storage media 30 (e.g., within elements 30-A, 30-B).

An example of metadata table 120 is shown below, in Table 1. In this example, a first data object 40A, stored on storage media 30 and corresponding to a first metadata value 40B (e.g., 0x1111) is associated with a first fidelity flag value (e.g., Boolean ‘True’), whereas a second data object 40A, stored on storage media 30 and corresponding to a second metadata value 40B (e.g., 0x2222) is associated with a second fidelity flag value (e.g., Boolean ‘False’), etc.

TABLE 1

| Metadata | Fidelity flag |
|---|---|
| (e.g. CRC value) | (e.g., Boolean value) |
| 0x11111 | True |
| 0x22222 | False |
| 0x33333 | True |

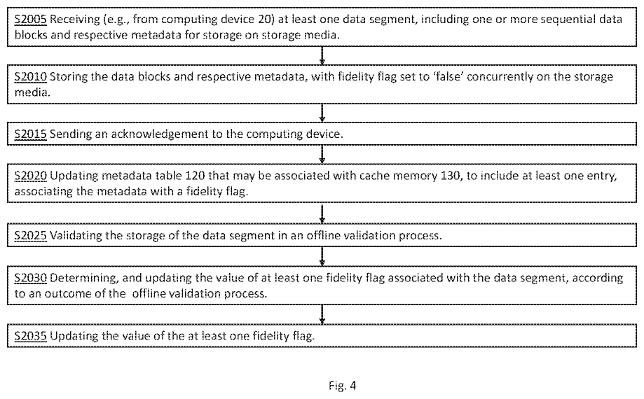

Reference is now made to FIG. 4, which is a flow diagram, depicting a method of handling storage of data segments by a storage control system (e.g. element 10 of FIG. 3).

As shown in step S2005, storage control system 10 may receive (e.g., from a computing device, such as element 20 of FIG. 3) a first request for storing at least one data segment (e.g., element 40A of FIG. 3) for storage on storage media (e.g., element 30 of FIG. 3). Data segment 40A may include for example, one or more sequential data blocks, as known in the art.

In some embodiments, data segment 40A may further include one or more metadata objects (e.g., element 40B of FIG. 3) that may correspond to the one or more data blocks. For example, at least one computing device or client 20 (e.g. 20-A, 20-B of FIG. 3) may send a write-access request, including a plurality of data blocks 40A to be stored, and one or more associated metadata object 40B (e.g. at least one hash value or CRC value associated with at least one data block of the data segment, as known in the art). Alternatively, or additionally, the one or more metadata objects 40B (e.g. the at least one hash value or CRC value) may be generated internally by at least one controller or processor (e.g., element 110 of FIG. 3) of storage control system 10.

As shown in step S2010, storage control system 10 may store the data blocks 40A and respective metadata 40B concurrently on storage media 30, as known to persons skilled in the art.

For example, computing device 20 may send a write-access request of a data segment 40A that spans 8 kilobytes (kB) and a respective metadata block 40B (e.g., a hash value), for storage on an NVM storage device (e.g., 30A, 30B). The NVM storage device may have or may be characterized for example, by a 512-byte deep atomic block. Storage control system 10 may split the write-access into 17 blocks (e.g., sixteen 512-byte data blocks+one 512-byte metadata block) and write the data to these 17 blocks concurrently. The term concurrently is used in this context to refer to an action that may be performed substantially at the same time, or overlapping in time, and may not require a plurality of iterations or communications with computing device 20.

Storage control system 10 may store a fidelity flag 40C, associated with at least one respective metadata object on the storage media. Fidelity flag 40C may correspond to a status of storage of at least one newly written data block 40A. For example: fidelity flag 40C may have a binary value of ‘False’, signifying that storage of a respective at least one data block 40A has not been validated, or has been validated and found erroneous. The fidelity flag may have a binary value of ‘True’, signifying that storage of a respective at least one data block has been verified and found to be correct.

In some embodiments, storage control system 10 may store fidelity flag 40C as part of the metadata block 40B. For example, the fidelity flag may be introduced by storage control system 10 as part of the stored metadata object.

Additionally, or alternatively, fidelity flag 40C may be stored in a separate table. For example, storage control system 10 may store an entry in a table (e.g., metadata table 120 of FIG. 3), that may include at least one content of a stored metadata block (e.g., a hash value) and at least one fidelity flag. Storage control system 10 may associate the metadata content with the fidelity flag by metadata table 120. As explained herein, the metadata object may be calculated (e.g., as a CRC or hash function) of a value of one or more data blocks stored on storage media 30 and may thus correspond to the one or more data blocks stored on storage media 30. Storage control system 10 may use metadata table 120 to maintain a status of fidelity (e.g., correctness) of storage of the at least one data block on storage media 30, as explained herein.

Additionally, or alternatively, storage control system 10 may attribute an initial ‘False’ value (e.g. a binary or other ‘False’ value, e.g. False=0; True=1) to fidelity flag 40C, e.g. set as false, signifying that the fidelity of the stored data has not yet been validated.

As shown in step S2015, storage control system 10 may send or transmit an acknowledgement to computing device 20 at this stage, to enable computing device 20 to utilize the storage media (e.g. elements 30-A, 30-B) at an optimal bandwidth: In some embodiments, the acknowledgement may only mark or indicate that storage system 10 has received (e.g., from device 20 (e.g., 20A. 20B)) a request for storage of one or more data elements 40A on storage media 30, and may not include an indication of fidelity, validity or correctness of the stored data and/or an indication of a success of the storage process. In other words, computing device 20 may not need to wait for a serial write process to be completed and may not need to wait for actual validation of the fidelity of storage by storage control system 10.

As shown in step S2020, storage control system 10 may update a metadata table (e.g., element 120 of FIG. 3) that may be associated with a cache memory (e.g., element 130 of FIG. 3) to include at least one entry that may associate a metadata element 40B (e.g. a hash value) of a newly written data block and/or data segment 40A with a respective fidelity flag 40C.

As shown in step S2025, storage control system 10 may be configured to validate the storage of the data segment in an offline validation process. The term ‘offline’ may be used herein to differentiate between a data storage process and a process of validation of the fidelity of stored data. This differentiation may be implemented timewise (e.g., by performing the two actions at different instances in time) or by computing resources (e.g., by different software processes and/or threads, by different hardware components and the like), according to available resources and/or priorities dictated by storage control system 10, and as known to persons skilled in the art. Various implementations of such offline validation processes are elaborated herein.

As shown in steps S2030 and S2035, storage control system 10 may be configured to determine the value of at least one fidelity flag 40C as one of ‘True (or ‘valid’) and ‘False’ (or ‘invalid’), associated with a stored data segment or data object 40A, according to an outcome of the offline validation process.

For example, storage control system 10 may set the value to ‘True’ if the validation was successful, or ‘False’ if the validation was unsuccessful. Additionally, or alternatively, if the offline validation process was unsuccessful, embodiments of the invention may discard, erase or purge stored metadata object 40B from storage media 30.

Storage control system 10 may update the value of the fidelity flag (e.g., to one of ‘True’ and ‘False’) in storage media 30 and/or in a metadata table (e.g., metadata table 120 of FIG. 3) accordingly, as elaborated herein.

Embodiments of the invention may validate the storage of the one or more data objects in an offline validation process. As elaborated herein, the offline validation process may for example, be one of:
offline rewriting of the stored data object by the one or more controllers 110;
offline reading of the stored data object by the one or more controllers 110;
offline reading of the stored data object by one or more client computing devices (e.g., by elements 20 such as 20A, 20B of FIG. 3); and
offline reading of the stored data object by a caching system (e.g., element 130 of FIG. 3).

In some embodiments, the offline validation process may be based on offline reading of stored data object 40A. For example, controller 110 may be configured to read the content of at least one data object 40A stored on storage media 30, and compute or produce at least one first metadata element 40B (e.g., a hash value, a CRC value and the like) therefrom. Controller 110 may compare the first, computed metadata 40B with content of a second metadata element or object 40B, that may be stored on storage media 30 and/or included within content of a cache memory (e.g., element 130 of FIG. 3). As part of the offline validation output or outcome, controller 110 may update the value of the fidelity flag in the storage media and/or in a metadata table (e.g., metadata table 120 of FIG. 3) according to the comparison.

For example, controller 110 may set or update the value to ‘True’ if the validation or comparison was successful (e.g., when the compared metadata elements are equal). Additionally, or alternatively, if the validation was unsuccessful (e.g., when the compared metadata elements are unequal), controller 110 may delete or purge the second metadata element or object 40B from storage media 30 and/or from cache memory 130.

Additionally, or alternatively, controller 110 may continuously and/or repeatedly update the value of at least one fidelity flag to maintain an overview of the fidelity of one or more data segments and/or objects stored in storage media 30 in a trigger-based, offline validation process. For example, controller 110 may be triggered to perform validation of fidelity flags (e.g. compare between computed metadata and stored metadata), by at least one of:
occurrence of an event (e.g., a data access request by at least one computing device 20);
lapse of a predefined period (e.g., an activation of a software or hardware timer interrupt, as known in the art); and
a background software process or task configured to browse through ‘False’ fidelity flags and perform validation thereof, etc.

As part of the offline validation process, upon occurrence of a triggering event, controller 110 may:
read a content of at least one data object 40A stored on storage media 30;
compute at least one first metadata element 40B (e.g., a hash value, a CRC value) therefrom;
compare the first, computed metadata with content of a second metadata element 40B, that may be stored on storage media 30 and/or included within cache memory 130; and
update the value of the fidelity flag according to the comparison, for example by setting or updating the value to ‘True’ if the validation or comparison was successful (e.g., when the compared metadata elements are equal). According to some embodiments, if the validation was unsuccessful (e.g., when the compared metadata elements are inequal), controller 110 may delete the respective, second metadata object 40B from storage media 30 and/or cache memory 130.

Additionally, or alternatively, the offline validation process may be based on offline rewriting of stored data object 40A. The rewriting of stored data object 40A may be referred to as offline in a sense that it may be performed separately or distinctly (e.g., at a different time, by a different hardware module, by a different software process, and the like) from the storage of data object 40A on storage media 30. In other words, the offline validation of storage of at least one data block may be performed when the data block is rewritten. For example, storage control system 10 may receive, from a first computing device 20, a first request for storing at least one data segment or object 40A. Data segment 40A may include one or more sequential data blocks and a respective one or more first metadata objects 40B. System 10 may store the data segment 40A and respective metadata on storage media 30. Storage control system 10 may then receive (e.g. from a second computing device 20) a second request to store the same data segment 40A. Again, data segment 40A may include one or more sequential data blocks and respective, one or more second metadata objects 40B. As part of the offline validation process, storage control system 10 may compare the one or more first, stored metadata objects 40B of the first request to the one or more second metadata objects 40B of the received, second request, to determine the fidelity of the stored data. System 10 may update the fidelity flag 40C in the storage media and/or in metadata table 120 accordingly, as an outcome or output of the offline validation process. For example, storage control system 10 may set the fidelity to be ‘True’ if the compared one or more first metadata objects 40B and the one or more second metadata objects 40B match (e.g., are equal). If the validation was unsuccessful (e.g., if a content of the compared metadata elements or objects 40B are unequal), controller 110 may delete the one or more stored, first metadata objects 40B from storage media 30.

Additionally, or alternatively, the offline validation process may be based on reading of stored data object 40A (e.g., by computing device 20). In other words, offline validation of storage of at least one data block may be performed when the data block is read (e.g., by an external computing device, such as elements 20A, 20B of FIG. 3).

As part of the offline validation process, storage control system 10 may be configured to:
read the at least one data block of a data segment 40A stored on storage device 30;
read at least one first respective metadata object 40B that is associated with the at least one read data block 40A and stored on the storage device 30;
produce at least one second metadata object 40B from the content of the at least one read data block 40A (e.g., storage control system 10 may perform a hash function on the content of the at least one data block to produce metadata such as a hash value or CRC that may correspond to the content of the data block);
compare the content of the at least one first, read metadata object 40B to the content of the at least one second, produced metadata objects 40B; and
set or update the fidelity flag 40C in the storage media 30 and/or in metadata table 120 according to the comparison. For example, storage control system 10 may set the value of the fidelity flag to be ‘True’ if the compared metadata objects match (e.g., are equal).

If the validation was unsuccessful (e.g., when the compared metadata elements are inequal), controller 110 may delete or purge the respective at least one first, stored metadata object 40B from storage media 30.

Additionally, or alternatively, the offline validation process may be performed by a client device or system. For example, controller 110 of storage control system 10 may receive a storage access request from a client (e.g. computing device 20), to read at least one stored data block 40A and associated stored metadata object 40B from storage media 30. The read-access request may include at least one first metadata object 40B (e.g., a hash value) that may be associated with the requested at least one data block 40A. Storage control system 10 may read the requested one or more data blocks 40A from storage media 30 and the at least one corresponding fidelity flag 40C (e.g., from storage media 30 and/or from metadata table 120).

As part of the offline validation process, client 20 may:
calculate a second metadata value 40B (e.g. a hash value, a CRC value) from the content of the one or more data blocks 40A read from the storage device; and
compare the calculated second metadata value 40B with the first metadata value included in the read-access request.

If the two metadata objects match (e.g., are equal), client 20 may determine that the data block was stored properly and may transmit or send a message (e.g., element 50 of FIG. 3) to notify storage system 10 to set or update the value of the fidelity flag associated with the at least one data block and/or segment to ‘True’. Storage system 10 may subsequently update the fidelity flag in the storage media and/or in metadata table 120 accordingly (e.g., update or set the value of the fidelity flag associated with the at least one data block and/or segment to ‘True’, as indicated in message 50).

Additionally, or alternatively, a client (e.g. computing device 20) may send or transmit a storage access request to storage control system 10, to read at least one stored data block 40A and associated stored metadata object 40B therefrom. Client 20 may first read the fidelity flag included within the stored metadata, and only perform the comparison of metadata objects as elaborated herein if the value of the fidelity flag is ‘False’ (e.g., in order to avoid wasting time on re-verification of stored data).

Reading or accessing at least one data block 40A stored on the at least one storage device (and consequent validation or invalidation of the respective fidelity) by system 10 may be triggered, initiated or prompted by a variety of conditions, that may be set or configured by an administrative user (e.g., via input device 7 of FIG. 2).

For example, storage control system 10 may receive (e.g. from a computing device such as client 20), a read-access request for reading the at least one data block and/or data segment from the at least one storage device, and may access storage media 30 to retrieve the requested data, as known in the art.

In another example, storage control system 10 may receive a synchronous or asynchronous interrupt or message from a software process, to prompt the reading of the at least one data block. For example, metadata table 120 may include (e.g., for each entry) a timestamp, associating a content of a metadata object with a timing of its storage on storage media 30, as shown in the example of Table 2:

TABLE 2

| Metadata | Fidelity flag | Timestamp |
|---|---|---|
| 0x11111 | True | T1 |
| 0x22222 | False | T2 |
| 0x33333 | True | T3 |

Controller 110 may execute a process that may emit a synchronous or asynchronous interrupt or message according to one or more stored timestamps, to prompt the reading and verification of the fidelity of at least one data block. For example, as shown in table 2, a fidelity flag associated with metadata 0x2222 is ‘False’ indicating for example, that the fidelity of storage of the respective data block 40A has not yet been verified. When a time represented by timestamp T2 elapses (e.g., according to a real-time clock (RTC) as known in the art), controller 110 may initiate reading of the respective data block to verify the fidelity status of the respective data object or segment 40A.

Additionally, or alternatively, storage control system 10 may receive a synchronous or asynchronous interrupt or message from at least one hardware module (e.g. a timer interrupt), prompting the reading of the at least one data block.

Additionally, or alternatively, validation of storage of at least one stored data block and/or data segment may be performed by comparing metadata associated with the at least one data block and/or data segment 40A with metadata stored on a cache memory device.

For example, storage control system 10 may receive a first request (e.g., data read request, data write request) to access (e.g., read or write) a data segment 40A on at least one storage device. Data segment 40A may include one or more data blocks, and the first request may include one or more first metadata objects 40B corresponding to content of the data object or segment 40A (e.g., hash values of the content of one or more data blocks). Storage control system 10 may be configured to store one or more metadata objects 40B associated with the data object or segment 40A of the first request in a metadata table (e.g., element 120 of FIG. 3), that may be associated with or included in a cache memory device (e.g., element 130 of FIG. 3). Storage control system 10 may then receive a second request to access the same data block and/or data segment 40A. The second request may include one or more second, respective metadata objects 40B (e.g., hash values) corresponding to content of the data object or segment 40A. Storage control system 10 may compare content of the one or more second metadata objects 40B of the second request to content of the one or more first metadata objects 40B, stored on cache memory device 130, to validate the fidelity of the stored data. Storage control system 10 may update or set the value of the fidelity flag in the storage media and/or in metadata table 120 accordingly. For example, storage control system 10 may update the value to ‘True’ if the validation was successful. Additionally, or alternatively, if the validation was unsuccessful, storage control system 10 may discard, erase or remove the one or more first metadata objects 40B from metadata table 120 and/or from cache memory device 130.

Embodiments of the system and method elaborated herein facilitate a practical application for handling storage of data by one or more client computing device(s) (e.g. computing device 20) (“clients”) on storage media. Embodiments of the invention may provide an improvement over state-of-the-art data storage systems by optimizing the process of data storage so as to enable the one or more clients to utilize an optimal work bandwidth. The term optimal may be used herein in a sense that:
the one or more clients may not need to wait for a first storage request of a serial write process to be completed successfully (e.g., wait for a ‘success’ acknowledgement) before sending a second request; and/or
the one or more clients may not need to wait for actual validation of the fidelity of a first storage to be completed by the storage control system before sending a second storage access request.

By performing offline validation of storage fidelity as elaborated herein, embodiments of the system may provide an additional improvement over state-of-the-art storage systems: embodiments may maintain a status of fidelity for each stored data block and identify data blocks that are stored improperly according to their status of fidelity. Embodiments may thus enable recovery from storage failures, while maintaining the optimal work bandwidth as elaborated herein, and avoiding consumption of computational resources (e.g., memory, CPU cycles, etc.) of client computers 20.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention. Further, features or elements of different embodiments may be used with or combined with other embodiments.

1. A method of performing data storage on computer storage media by at least one controller, the method comprising:
receiving from a computing device a first storage-access request for storing at least one data segment, comprising one or more first data blocks and at least one first metadata object, wherein content of the at least one first metadata object corresponds to content of the one or more first data blocks;
storing the one or more first data blocks and the at least one first metadata object on the storage media;
sending an acknowledgement to the computing device; and
validating the storage of the one or more data blocks in an offline validation process.

2. The method of claim 1, wherein storing the one or more data blocks and the at least one first metadata object on the storage media is performed concurrently.

3. The method of claim 1, comprising:
storing at least one fidelity flag associated with at least one respective metadata object;
attributing an initial ‘False’ value to the at least one fidelity flag;
determining a value of at least one fidelity flag according to an outcome of the offline validation process; and
updating the value of the stored fidelity flag.

4. The method according to claim 3, further comprising: if the offline validation process fails, then deleting the at least one first metadata object.

5. The method of claim 3, comprising maintaining a metadata table, wherein at least one entry is configured to associate a content of at least one metadata object to at least one fidelity flag, so as to maintain a condition of fidelity of at least one data block stored on the storage media.

6. The method according to claim 3, wherein the offline validation process comprises:
receiving, from a computing device, a second request for storing the at least one data segment, wherein the second request comprises at least one second metadata object; and
comparing content of the at least one second metadata object with content of the at least one first metadata object stored on the storage media.

7. The method according to claim 3, wherein the offline validation process comprises:
reading, by the controller, the one or more first data blocks stored on the storage media;
reading, by the controller, the at least one first, respective metadata object stored on the storage media;
producing, by the controller, at least one second metadata object from the one or more first, read data blocks; and
comparing, by the controller, the content of the at least one first read metadata object to the content of the at least one second, produced metadata object.

8. The method according to claim 7, wherein reading the one or more first data blocks is prompted by at least one of:
receiving, from a computing device, a request for reading the at least one data block from the storage media;
receiving an asynchronous interrupt or message from at least one hardware module;
receiving a synchronous interrupt or message from at least one hardware module;
receiving at least one asynchronous interrupt or message from a software process; and
receiving at least one synchronous interrupt or message from a software process.

9. The method according to claim 3, wherein the offline validation process comprises:
receiving a first request to access the at least one data segment on the storage media, wherein the first request comprises one or more first metadata objects corresponding to content of the one or more first data blocks;
storing the one or more first metadata objects in a cache memory device;
receiving a second request to access the data segment, comprising one or more second metadata objects; and
comparing the content of one or more second metadata objects to the content of one or more first metadata objects that are stored on the cache memory device.

10. The method according to claim 3, wherein the offline validation process comprises:
receiving, from a computing device, a storage access request to read one or more data blocks from the storage media, wherein the request comprises at least one first metadata value;
reading the one or more data blocks and at least one corresponding fidelity flag from the storage media;
if the value of the fidelity flag is ‘False’, then calculating, by the computing device, a second metadata value from the content of the one or more read data blocks; and
if the first metadata value and the second metadata value match, then updating the value of the fidelity flag to ‘True’.

11. A system for handling data on at least one storage device, the system comprising: a non-transitory memory device, wherein modules of instruction code are stored, and a controller associated with the memory device, and configured to execute the modules of instruction code, whereupon execution of said modules of instruction code, the controller is configured to perform at least one of:
receive, from a computing device, a first storage-access request for storing at least one data segment, comprising one or more data blocks and at least one first metadata object, wherein content of the at least one first metadata object corresponds to content of the one or more data blocks;
store the one or more data blocks and the at least one first metadata object on the at least one storage device;
send an acknowledgement to the computing device; and
validate the storage of the one or more data blocks in an offline validation process.

12. The system of claim 11, wherein the controller is configured to store the one or more data blocks and the at least one metadata object concurrently on the storage media.

13. The system of claim 12, wherein the controller is configured to:
store at least one fidelity flag associated with at least one respective metadata object;
attribute an initial ‘False’ value to the at least one fidelity flag;
determine a value of the at least one fidelity flag according to an outcome of the offline validation process; and
update the value of the stored fidelity flag.

14. The system of claim 13 wherein the controller is further configured to delete the at least one first metadata object if the offline validation process fails.

15. The system of claim 13, wherein the controller is configured to maintain a metadata table, wherein at least one entry is configured to associate a content of at least one metadata object to at least one fidelity flag, so as to maintain a condition of fidelity of at least one data block stored on the at least one storage device.

16. The system according to claim 13, wherein the controller is configured to perform an offline validation process by:
receiving, from a computing device, a second request for storing the at least one data segment, wherein the second request comprises at least one second metadata object; and
comparing the content of the at least one second metadata object with content of the at least one metadata object stored on the at least one storage device.

17. The system according to claim 13, wherein the controller is configured to perform an offline validation process by:
reading the one or more first data blocks stored on the one or more storage devices;
reading the at least one first, respective metadata object stored on the one or more storage device;
producing at least one second metadata object from the one or more first, read data blocks; and
comparing the content of the at least one first read metadata object to the content of the at least one second, produced metadata object.

18. The system according to claim 13, wherein the controller is configured to perform an offline validation process by:
receiving a first request to access the at least one data segment on the at least one storage device, wherein the first request comprises one or more first metadata objects corresponding to content of the one or more first data blocks;
storing the one or more first metadata objects in a cache memory device;
receiving a second request to access the data segment, comprising one or more second metadata objects; and
comparing the content of one or more second metadata objects to the content of one or more first metadata objects that are stored on the cache memory device.

19. The system according to claim 13, wherein the controller is further configured to:
receive, from a computing device, a storage access request to read one or more data blocks from the storage media, wherein the request comprises at least one first metadata value;
read the one or more data blocks and at least one corresponding fidelity flag from the storage media;
if the value of the fidelity flag is ‘False’, then calculate, by the computing device, a second metadata value from the content of the one or more read data blocks; and
if the first metadata value and the second metadata value match, then update the value of the fidelity flag to ‘True’.

20. A method of performing offline validation of data storage on computer storage media by one or more controllers, the method comprising:
receiving a one or more data objects;
calculating at least one metadata value from the content of the one or more data objects;
storing the one or more data objects and the at least one metadata value on the storage media; and
validating the storage of the one or more data objects in an offline validation process.

21. The method of claim 20, wherein the offline validation process is selected from a list consisting of:
offline rewriting of the stored data object by the one or more controllers;
offline reading of the stored data object by the one or more controllers;
offline reading of the stored data object by one or more client computing devices; and
offline reading of the stored data object by a caching system.

22. The method of claim 20, further comprising:
storing at least one fidelity flag associated with at least one respective metadata object on the storage media;
attributing an initial ‘False’ value to the at least one fidelity flag; and
updating the value of at least one fidelity flag according to an outcome of the offline validation process.

23. The method according to claim 22, further comprising: if the offline validation process fails, then deleting the at least one first metadata value from storage.
